(19) United States
(12) Patent Application Publication
(10) Pub. No.: US 2013/0270430 A1
(43) Pub. Date: Oct. 17, 2013

(54) SYSTEM FOR MONITORING ENVIRONMENTAL DOSIMETRY, DOSIMETER AND ENVIRONMENTAL DOSIMETRY METHOD

(71) Applicants: Patrick Pailler, Fontaine le Comte (FR); Christian Chatellier, Poitiers (FR); Yoann Hilairet, Poitiers (FR); Grégory Jean, Caen (FR)

(72) Inventors: Patrick Pailler, Fontaine le Comte (FR); Christian Chatellier, Poitiers (FR); Yoann Hilairet, Poitiers (FR); Grégory Jean, Caen (FR)

(73) Assignee: WYTEK, Poitiers (FR)

(21) Appl. No.: 13/988,184

(22) PCT Filed: Nov. 17, 2011
(86) PCT No.: PCT/IB2011/055150

§ 371 Date: Jun. 21, 2013

(30) Foreign Application Priority Data
Nov. 17, 2010 (FR) 1004482

(51) Int. Cl. G01T 1/02

(52) U.S. Cl. CPC G01T 1/026
USPC 250/252.1; 250/370.07

(57) ABSTRACT

The invention relates to a real-time dosimetry monitoring system which is simple to deploy, efficient and economical and which limits the production of waste. For this purpose, the subject of the invention is a system for monitoring environmental dosimetry, comprising: a plurality of dosimeters (100, 110) not equipped with a display screen or radioactive dose calculator, but each comprising a photodiode (101) sensitive to the radiation to be detected and a discriminator (102) that transforms a pulse representative of radiation detection into a pulse that can be counted by a supervision unit (103), said supervision unit being connected to a wireless transceiver (104) for transmitting raw data representative of the radiation detected by each dosimeter; and at least one relay terminal (200) comprising a wireless transceiver (201) that can communicate with at least some of the transceivers of the dosimeters and with at least one central unit (300) for tracking environmental dosimetry, said central unit being able to calculate the radiation dose sensed by each dosimeter on the basis of the raw data transmitted by each dosimeter.

The invention relates to a system for monitoring environmental dosimetry, a dosemeter for measuring environmental radioactivity and an environmental dosimetry method.

A dosemeter is an appliance which measures radiations. Dosemeters are used to monitor a radioactive environment in a room or to monitor the quantity of radiation to which a user of the dosemeter is exposed.

The present invention relates to the measurement of environmental radioactivity.

More particularly, a dosemeter measures the ambient dose equivalent (or the rate), and/or the directional dose equivalent (or the rate) due to the external exposure to beta, X and gamma radiations, for energies below 10 MeV, for the purpose of radio protection.

The method for determining the ambient and directional dose equivalent (or the rate) at the test point is given in standard ISO 4037-3.

An ambient dose equivalent, denoted H*(10), is a dose equivalent at a point in a radiation field that would be produced by the corresponding aligned and expanded field, in the ICRU sphere, at a depth of 10 mm, on the radius vector opposing the direction of the unidirectional field.

The international system unit of dose equivalent is J.kg⁻¹. Its special name is the sievert (Sv): 1 Sv=1 J.kg⁻¹.

Most environmental dosemeters are said to be passive. They consist of a strip of radiation-sensitive material. When a photon passes through this strip, the latter is exposed in the manner of a photographic film. These are called passive badges.

These badges are distributed in rooms, or on appliances, where radioactivity has to be monitored. At the end of a defined time period, dependent on current legislation, the passive badges are recorded and their precise position referenced to ensure the traceability of the information. Once the badges have been collected (and replaced with new passive passages), they are sent to a laboratory for analysis. This can take several days so that the knowledge of a radioactivity incident is necessarily offset in time relative to the occurrence of the incident itself. This is how the incorrect adjustment of radiotherapy instruments happens to have been detected only several days later. If this delay could have been shortened, the contamination of many patients could have been avoided.

In addition to this significant detection delay, the passive badges currently used require scrupulous management for their positioning, their collection, the referencing of their position, their sending to the analysis laboratories, the collection of the results and the drafting of the reports. The time spent in managing the environmental dosimetry measurement can represent several full-time workers for the bigger hospitals.

Finally, the single use of the environmental dosemeters generates excessively high costs, but also significant waste, further increasing the waste reprocessing costs.

There is another type of dosemeter. These are so-called active dosemeters, consisting of an electronic appliance comprising an electrical power supply linked to a measurement system sensitive to the radiations to be detected. As soon as the detector receives radiations, it calculates the dose received and sends the result to a display screen. This dosemeter structure is mandatory according to certain standards, such as, for example, the standard NF EN 61526 relating to direct reading dosemeters used in operational dosimetry, that is, dedicated to the protection of individuals, and it has to be worn by the user.

The users must necessarily connect their active dosemeter to a data collection terminal when they leave the monitored area. The only advantage that these electronic dosemeters provide is the immediate calculation of the detected radiation dose, this dose being able to be known as soon as the dosemeters are connected to the dosimetry tracking terminal, without having to wait several days or weeks.

This type of dosemeter cannot therefore replace the passive badges used in currently existing environmental dosimetry because they represent a very high cost, and the data recovery infrastructure designed for operational dosimetry is not suited to environmental dosimetry. The data collection is just as costly and demanding as for the environmental dosemeters since it would be necessary to go and regularly record in situ the doses calculated and displayed by each dosemeter.

The present invention therefore aims to provide a system for monitoring environmental dosimetry that makes it possible to know centrally and almost immediately the dose detected by all the dosemeters deployed in a room or a building. This system, which uses wireless communications, is easy to deploy in pre-existing premises without having to carry out any significant installation work, efficient because some of the maintenance can be performed remotely, and cost effective because no installation/deinstallation management is required and only a limited mandatory annual maintenance is required and waste production is avoided.

To remedy this problem, the invention proposes a system for monitoring environmental dosimetry comprising dosemeters that are very energy efficient and that can communicate remotely with a central unit which in turn performs the dose calculations received by the dosemeters from the raw data transmitted by the dosemeters.

The person skilled in the art would not be prompted to modify the operational dosemeters of the state of the art to allow for an easier collection of the calculated doses because, by equipping such dosemeters with a wireless transceiver, the electrical consumption would be very significant and it would be necessary to replace the cells or recharge the batteries at least every week. The cost of the electrical consumption would therefore be prohibitive, the handling involved would be just as great as is currently necessary in environmental dosimetry for replacing the passive badges, and the quantity and the cost of the waste generated would be even greater if the electrical power supply were provided by non-rechargeable batteries.

More specifically, the subject of the invention is a system for monitoring environmental dosimetry, comprising:
a plurality of dosemeters not equipped with a display screen, each comprising a photodiode sensitive to the radiations to be detected, a discriminator that transforms a pulse representative of the detection of a radiation into a pulse that can be counted by a control unit, at least one charge amplifier arranged between the photodiode sensitive to the radiations to be detected and the discriminator, the control unit being in turn connected to a wireless transceiver for the transmission of data representative of the radiations detected by each dosemeter;
at least one relay terminal comprising a wireless transceiver suitable for communicating with at least some of the transceivers of the dosemeters and with at least one central unit for tracking the environmental dosimetry.

According to other embodiments:
the plurality of dosemeters may also not be equipped with any radioactive dose computer, the control unit being suitable for transmitting, via the wireless transceiver, raw data representative of the radiations detected by each dosemeter, and the central unit being suitable for calculating the radiation dose picked up by each dosemeter from the raw data;
the transceiver of each dosemeter may operate asymmetrically such that each dosemeter has less time for transmitting raw data than time for receiving information from said at least one central unit via said at least one relay terminal;
the system may also comprise a memory for storing the doses calculated by the central unit; and/or
the system may also comprise an alarm that can be activated by the central unit in the case where a calculated dose exceeds a predefined threshold.

The invention also relates to a dosemeter for implementing the system for monitoring environmental dosimetry according to the invention, comprising at least one photodiode sensitive to the radiations to be detected, characterized in that the or each photodiode is connected to a control unit via a discriminator that transforms a pulse representative of the detection of a radiation into a pulse that can be counted by the control unit, at least one charge amplifier arranged between the photodiode sensitive to the radiations to be detected and the discriminator, the control unit being in turn connected to a transceiver for the transmission of the data detected by the diode, the dosemeter not being equipped with a display screen.

According to other embodiments:
the dosemeter can preferentially not be equipped with a computer for calculating the detected radioactive dose, the control unit being suitable for transmitting, via the transceiver, the raw data generated by the discriminator;
the control unit may comprise a clock for controlling the transceiver asymmetrically so that it has a transmission time that is shorter than a reception time;
the control unit may be linked to a calibration filter suitable for transforming binary pulses, transmitted by the control unit and with a parameterizable duration, into pulses identical to what the photodiode produces when it is subjected to a radiation in order to adjust the discriminator;
the control unit may be linked to a potentiometer that can be controlled by the control unit to electrically adjust a discriminator radiation detection threshold; and/or
the control unit may be linked to a diode which is switched on under the control of the control unit and which is arranged to illuminate the photodiode sensitive to the radiations to be detected in order to check the correct operation of the dosemeter.

The invention also relates to an environmental dosimetry method using a system for monitoring environmental dosimetry according to the invention and comprising the following steps:
a) activating the dosemeters;
b) converting electrical signals generated by the photodiode of each dosemeter into a data signal representative of the detected radiations;
c) sending at least a part of the data signal via the wireless transceiver to the central unit, possibly via at least one relay terminal.

According to other embodiments:
the step b) may consist in converting electrical signals generated by the photodiode of each dosemeter into a raw data signal, the method also comprising a step d) of calculating, with the central unit, the dose of radiations picked up by each photodiode from the transmitted raw data signal;
the method may also comprise a step of calculating the dose of radiations picked up by each photodiode per time unit, the dose rate, to determine the change in trend over time of the dose picked up;
the method may also comprise a step of activation of an alarm when the dose rate exceeds a predetermined threshold;
the transceiver of each dosemeter may be controlled asymmetrically so that it has a transmission time that is shorter than a reception time;
the raw data signal of the step b) may be a binary signal, and the step c) may consist in sending all of the binary signal;
the raw data signal of the step b) may be a binary signal, and the step c) may consist in sending only a part of the binary signal, this part corresponding to an actual detection of a radiation, the untransmitted part corresponding to the absence of detection;
the method may also comprise a step of testing the operation of one or more dosemeters, this step comprising the following substeps:
   sending a test command from the central unit to one or more dosemeters, this test command being received by the wireless receiver of the or each dosemeter;
   transmitting the received test command to the control unit;
   ordering, via the control unit, a diode arranged to illuminate the photodiode sensitive to the radiations to be detected to be switched on for a predefined duration;
   converting electrical signals generated by the photodiode of each dosemeter into a data signal;
   sending at least a part of the data signal via the wireless transceiver to the central unit, possibly via a relay terminal;
   using the central unit to check that the received signal corresponds to the test command sent;
   activating an alarm if the received signal does not correspond to the test command,
the method may also comprise a step of generating an alarm signal when the calculated dose exceeds a predetermined tolerance threshold, or when a communication failure between a dosemeter and the central unit is detected, or when a failure of operation of a dosemeter is detected;
the method may also comprise a calibration step comprising the following substeps:
   sending a calibration command from the central unit to one or more dosemeters, this calibration command being received by the wireless receiver of the or each dosemeter;
   transmitting the received calibration command to the control unit;
   in the absence of any irradiation of the photodiode, searching, with the control unit, for a position of a potentiometer that can be controlled such that the discriminator does not send any pulse despite an electronic noise from the charge amplifier;
   generating, with the control unit, at least three series of a defined number of binary pulses of fixed amplitude, the pulses of the first series having a duration of 10 μs, the pulses of the second series having a duration of 20 μs, the pulses of the first series having a duration of 30 μs, the other series having a pulse duration incremented by 10 μs between each series, these binary pulses being transmitted to a calibration filter;
   transforming, with the calibration filter, the binary pulses into pulses identical to what the photodiode produces when it is subjected to a photon;
   counting the number of pulses generated by the discriminator and transmitted to the control unit for each series of pulses;
   establishing a ratio between the number of pulses of each series and the number of pulses generated in response by the discriminator;
   adjusting the controllable potentiometer until approximately 10% of the pulses of the first series generate a response from the discriminator, approximately 30% of the pulses of the second series generate a response from the discriminator and approximately 50% of the pulses of the third series generate a response from the discriminator; and/or
the method may also comprise a step of adjusting the detection sensitivity of one or more dosemeters, comprising the following substeps:
   measuring the sensitivity of one or more dosemeters at different energies between 10 and 3000 keV (kilo electron volt) relative to cesium 137;
   if the sensitivity of one or more dosemeters is greater than 1.4 or less than 0.6:
      sending a sensitivity adjustment command from the central unit to the dosemeter or dosemeters, this sensitivity adjustment command being received by the wireless receiver of the or each dosemeter;
      transmitting the sensitivity adjustment command to the control unit;
      controlling, via the control unit, a controllable potentiometer to adjust the detection threshold of the discriminator until the sensitivity of the dosemeter or dosemeters is between 0.6 and 1.4.

Other features of the invention will emerge from the following detailed description, given with reference to the appended figures which represent, respectively:

FIG. 1, a schematic representation of a system for monitoring environmental dosimetry according to the invention;

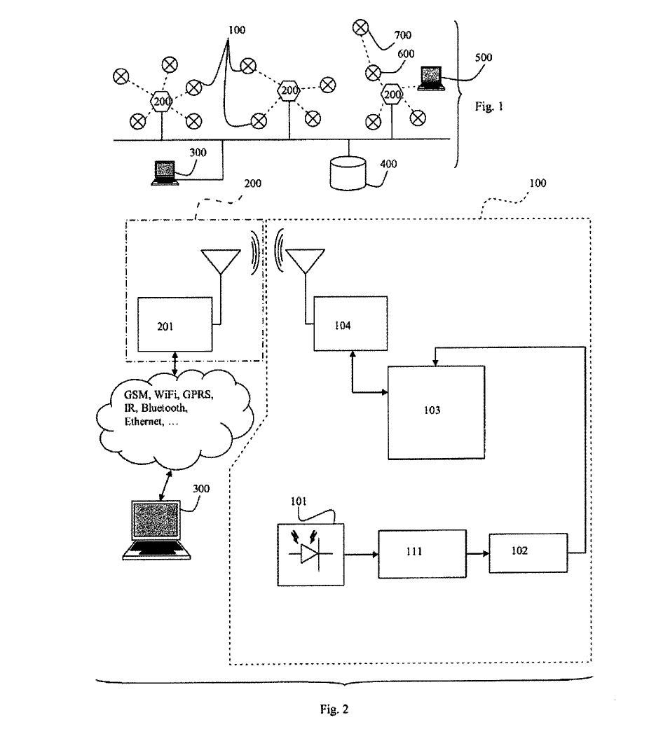

FIG. 2, a schematic representation of a system for monitoring environmental dosimetry according to the invention provided with a dosemeter according to the invention;

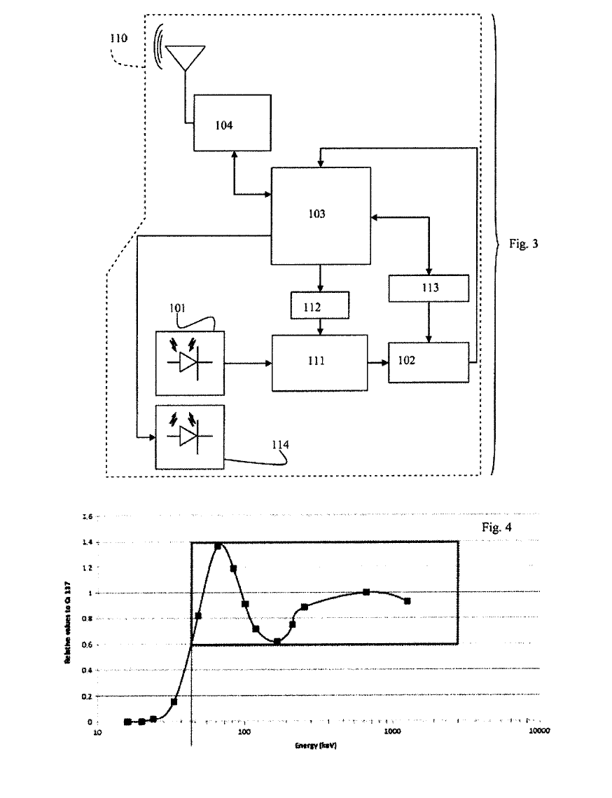

FIG. 3, a schematic representation of a second embodiment of a dosemeter according to the invention; and

FIG. 4, a curve representing the sensitivity of a dosemeter according to the invention at different energies relative to cesium 137.

A system for monitoring environmental dosimetry according to the invention is illustrated schematically in FIGS. 1 and 2. The solid lines between the various elements of the system represent wired communications and the broken lines represent wireless links.

This system comprises a plurality of dosemeters 100 each comprising at least one photodiode 101 sensitive to the radiations to be detected, at least one discriminator 102 that transforms a pulse representative of the detection of a radiation by the or each photodiode 101 into a pulse that can be counted by a control unit 103, at least one charge amplifier 111 arranged between the photodiode sensitive to the radiations to be detected and the discriminator, the control unit being in turn connected to a wireless transceiver 104 for the transmission of raw data representative of the radiations detected by each dosemeter.

The charge amplifier 111 amplifies the signal supplied by the photodiode 101 when a photon passes through it. This amplifier must be chosen to minimize as far as possible the electrical consumption.

According to the invention, the dosemeters are not equipped with a display screen, which makes it possible to save on energy. Advantageously, the dosemeters according to the invention are also not equipped with a radioactive dose computer and transmit only at least a part of the raw data, preferably binary data. Also advantageously, the dosemeters according to the invention are not equipped with any audible or visual alarm.

The control unit 103 can be any type of programmable logic circuit, such as a microcontroller, an FPGA (field-programmable gate array), an SOC (system on chip) which offers the benefit of incorporating both a microcontroller 103 and a radio transceiver 104, etc.

The system according to the invention also comprises at least one relay terminal 200 comprising a wireless transceiver 201 suitable for communicating with at least some of the transceivers 101 of the dosemeters 100 and with at least one central unit 300 for tracking the environmental dosimetry.

The central unit 300 is suitable for receiving the radiation dose calculated by each dosemeter, but, alternatively and preferentially, the central unit 300 is suitable for calculating the radiation dose picked up by each dosemeter on the basis of the raw data transmitted by each dosemeter 100. In this preferential embodiment, the dosemeters do not themselves calculate the received dose, which makes it possible to save on electrical energy.

The monitoring of the environmental dosimetry according to the invention comprises the following steps:
a) activating the dosemeters;
b) converting the electrical signals generated by the photodiode of each dosemeter into a raw data signal;
c) sending at least a part of the raw data signal via the wireless transceiver to the central unit, possibly via a relay terminal;
d) with the central unit, calculating the dose of radiations picked up by each photodiode from the transmitted raw data signal.

In this way, the dosemeters (which are electrically powered by cells or by rechargeable batteries) consume little energy because the dose is calculated remotely by the central unit 300 which is itself linked to the electrical network.

The central unit 300 is advantageously linked to a memory 400 which can store the calculated doses received by each dosemeter, but also the raw data, the time of transmission of the data, the trend of the calculated dose received per time unit to determine the trend over time of the dose picked up, etc.

This memory may comprise at least one hard disc, flash memory, a USB key, a CD ROM or a Blue Ray disc, a magnetic cassette, or any other data storage device.

Each dosemeter may also store its own raw data in a specific memory, such as a flash memory for example.

Obviously, other appliances can communicate with the relay terminals 200, such as laptop computers 500, personal digital assistants (PDAs), cell phones, etc.

Advantageously, the system for monitoring environmental dosimetry according to the invention comprises an alarm that can be activated by the central unit in the case where a calculated dose exceeds a predefined threshold.

The monitoring of the environmental dosimetry according to the invention may also comprise a step of calculating the radiation dose picked up by each photodiode per time unit to determine the trend over time of the dose picked up (dose rate).

The monitoring of the environmental dosimetry according to the invention may also comprise a step of activating an alarm if the trend over time of the dose picked up exceeds a predetermined threshold.

By virtue of the wireless transmission between the dosemeters according to the invention and the relay terminal or terminals, the system for monitoring environmental dosimetry according to the invention can be very easily deployed in different rooms and/or in different buildings, as may be the case in certain hospitals.

With the current technologies, it is very easy to install relay terminals 200 with sufficient range to communicate with a plurality of communicating dosemeters according to the invention. The person skilled in the art will be perfectly capable of optimizing the placement of the relay terminals according to the configuration of the building or buildings to be equipped to monitor the environmental dosimetry.

Regarding the dosemeters 100, all that is required is to place them in the rooms to be monitored or on the appliances to be monitored, as for the passive environmental dosimetry badges known from the prior art. Unlike the latter, the dosemeters according to the invention do not require periodical installation/de-installation (daily, weekly or monthly). Furthermore, their electrical consumption is very low so that an autonomy of several months, even at least one year, can be achieved.

In practice, by virtue of the absence of any display screen, the system for monitoring environmental dosimetry according to the invention makes it possible to optimize the electrical consumption of the dosemeters according to the invention.

Preferentially according to the invention, the transceiver of each dosemeter also operates asymmetrically such that each dosemeter has less time for transmitting raw data than time for receiving information from said at least one central unit via said at least one relay terminal. A distinction is drawn between the transmission time and the transmission itself, in the same way as a distinction is drawn between the reception time and the reception itself. In other words, it is not because the transceiver is in transmission mode that it transmits data: the data transmission can be shorter than the transmission time. Similarly, it is not because the transceiver is in reception mode that it receives data.

By virtue of this asymmetrical operation, the dosemeters do not waste energy by continuously transmitting to the central unit via the relay terminals. The transmission takes place only at regular intervals, between much longer “listening” periods. To this end, the control unit 103 of each dosemeter 100 comprises a clock for controlling the transceiver asymmetrically so that it has a transmission time that is shorter than a reception time. This technical feature also makes it possible to save on the energy resource of each dosemeter.

For example, the remote dosemeter can be set to transmit (with speech) during a very short time of 2 ms and to receive (listening time) for a time of 30 ms (when it receives, for example, a reception acknowledgement). The electrical consumption in listening mode is lower than in transmission mode. In this context, a frame can be sent every 30 seconds for 1 year, or around 1 million frames per year. In this example, the embedded energy must have a capacity of the order of 2200 mAh.

The dosemeters 100 transmit only binary data by virtue of the transformation, by their discriminator 102, of the pulses transmitted by their photodiode 101 into pulses that can be counted by their control unit 103.

Thus, the dosemeters do not expend electrical energy in calculating the radiation dose received and in transmitting this value coded on a plurality of bits. They transmit only 1s (corresponding to a pulse transmitted by the photodiode) and 0s (corresponding to the absence of pulse transmitted by the photodiode), which constitutes both a saving in calculation energy and an optimization of the transmission in terms of quantity and speed, the 1s and the 0s being values that are very easy to transmit without coding on several bits, unlike what would be the case if the dosemeter had to send the value of the dose and its unit. It is only the central unit which calculates the dose received from the data transmitted by each dosemeter. Furthermore, the dosemeters according to the invention are not equipped with a display screen.

During the step of sending raw data (step c)), all the binary signal can be sent.

Advantageously, to save more energy, only a part of the binary signal is sent to the central unit, this part corresponding to an actual detection of a radiation (sending 1s of the binary signal), the untransmitted part (the 0s of the binary signal) corresponding to the absence of detection.

It is interesting to note that each dosemeter does not transmit any data if it does not detect any radiation, as long as there are elements indicating that the dosemeter is operating correctly and that it is part of the network. For this, the central unit can interrogate it at regular intervals and test it as will be described below. Alternatively, each dosemeter can transmit to the central unit 300, at regular intervals relatively far apart, a so-called “polling” signal, according to which the dosemeter is still active and present on the network. Without the reception of this signal (network or dosemeter electrical power supply problem), the central unit 300 can be configured to activate an alarm in the event of failure of a dosemeter, radio or electrical power supply failure.

The dosemeters according to the invention can thus offer an autonomy of several months, even at least one year.

This system for monitoring environmental dosimetry according to the invention is therefore simultaneously easy to deploy, energy efficient and allows for a “real-time” monitoring of the environmental dosimetry by the central unit 300. Furthermore, for example in the case of a threshold overshoot, a worrying trend, a network failure or a failure of the cells/batteries, an alarm can be transmitted by the central unit and also transmitted to the other devices capable of communicating with the relay terminals, such as the PDAs of the doctors, of the nurses or of the skilled radio protection technicians.

The type of wireless communication is advantageously chosen to have sufficient range to limit the number of relay terminals 200 and to be able to communicate through the structure of the buildings. Advantageously, a radio communication (such as WiFi 802.11.n or preferentially Zig Bee 802.15.4) will be chosen between the dosemeters 100 and the relay terminals 200.

As for the latter, they can be equipped with several types of communication means, so as to be able to communicate with, of course, the central unit 300 and the dosemeters 100, but also other types of appliances such as cell phones, PDAs, personal computers, etc. For example, the relay terminals may be equipped for wired communication, of Ethernet or PLC (powerline communication) type, and/or for wireless communication, of GSM, WiFi, Zig Bee, GPRS, Bluetooth, Infrared, or other such type.

A second embodiment of a dosemeter according to the invention is illustrated in FIG. 2.

This embodiment makes it possible to use the potential that the invention confers on the dosemeter of electrically receiving information from the central unit 300 via the relay terminals 200.

In addition to the fact that it comprises the same components 101, 102, 103 and 104 as the embodiment 100 of FIG. 2, this second embodiment comprises a controllable potentiometer 113 (E²POT) arranged between the discriminator and the control unit 103, and a calibration filter 112 arranged between the control unit 103 and the charge amplifier 111.

An exemplary embodiment of a dosemeter according to the invention may comprise the following electronic components:
a Bpw34 PIN silicon photodiode from the company Siemens;
an H4083 amplifier from the company Hamamatsu;
an MCP6546/LP211DR single open-drain discriminator from the company Microchip/Texas Instruments;
an AD5259 E²POT controllable potentiometer from the company Analog Devices;
an MSP430 control unit from the company Texas Instruments; and
a CC2500 transceiver from the company Texas Instruments.

Once a year, the dosemeter must be calibrated, that is to say it must be checked to ensure that it is indeed measuring the correct dose values within the energy range that is specific to it. During this calibration, a self-calibration is first of all performed in order to reposition the detection threshold of the discriminator. Then, the dosemeter is irradiated in order to see if the response is still as it should be. If the response is incorrect its sensitivity can be adjusted with the controllable potentiometer (E²POT) 113.

To this end, the calibration filter 112, linked to the control unit 103, is suitable for transforming a binary pulse, transmitted by the control unit and with a parameterizable width, into a pulse identical to what the photodiode produces when it is subjected to a radiation in order to calibrate the discriminator.

In fact, with no radiation detected, the output of the charge amplifier 111 exhibits an amplitude noise Δ_{B}. The detection threshold of the discriminator 102 must therefore be set so that counting takes place only when a radiation is detected and not because of the noise of the charge amplifier 111.

The self-calibration comprises a first step of sending a calibration command from the central unit 300 to one or more dosemeters 110, this calibration command being received by the wireless receiver 104 of the or each dosemeter.

Then, the received calibration command is transmitted to the control unit 103.

Then, in the absence of any irradiation of the photodiode 101, the control unit 103 is used to search for a position of the potentiometer 113 that can be controlled such that the discriminator 102 does not send any pulse despite the electronic noise from the charge amplifier 111. In practice, from an initial position of the controllable potentiometer, the position is modified until the generation of a pulse by the discriminator stops if, at the initial position, the discriminator generates pulses despite the absence of irradiation (these pulses are then due to the electronic noise of the amplifier), or until the generation of a pulse by the discriminator is provoked if, at the initial position, the discriminator does not generate any pulse. In the latter case, there is a return to a position of the controllable potentiometer in which the discriminator no longer generates any pulse.

Then, the control unit 103 is used to generate at least three series of a defined number of binary pulses of fixed amplitude (for example 3.3 volts), the pulses of the first series having a duration of 10 μs, the pulses of the second series having a duration of 20 μs, the pulses of the third series having a duration of 30 μs. The number of pulses of each series is, for example, a million.

Other series can be generated and the duration of each pulse is then incremented by 10 μs between each series. These binary pulses are then transmitted to the calibration filter 112. The calibration filter thus transforms the binary pulses into pulses identical to what the photodiode produces when it is subjected to a photon. The variable duration of the pulses makes it possible to vary the energy of the pulses received by the amplifier.

Then, the number of pulses generated by the discriminator and transmitted to the control unit 103 for each series of pulses is counted, and then a ratio is established between the number of pulses of each series and the number of pulses generated in response by the discriminator.

Finally, the controllable potentiometer is adjusted until approximately 10% of the pulses of the first series generate a response from the discriminator, approximately 30% of the pulses of the second series generate a response from the discriminator and approximately 50% of the pulses of the third series generate a response from the discriminator.

An optimum detection threshold specific to each dosemeter is therefore obtained.

However, the standards demand that the sensitivity of the dosemeters be located between 1.4 and 0.6 relative to cesium 137.

The optimum detection threshold determined by the self-calibration may be below this sensitivity. It is therefore necessary to “degrade” the sensitivity of the dosemeter so that it falls within the standard.

The controllable potentiometer 113 (E²POT) makes it possible to electrically adjust the sensitivity of the dosemeter.

To know the sensitivity of each dosemeter, the energy response curve of the dosemeter, which is given in FIG. 4, must be measured.

This entails knowing the number of pulses counted per unit of radioactivity. The sievert and its subunits millisievert (mSv) and microsievert (μSv) are generally used in this domain.

This curve represents the sensitivity of the dosemeter at different energies relative to cesium 137 which has a sensitivity of 1.

Adjusting the detection sensitivity of one or more dosemeters comprises the following steps:
measuring the sensitivity of one or more dosemeters at different energies between 10 and 3000 keV (kilo electron volt) relative to cesium 137 which has a sensitivity set arbitrarily at 1;
if the sensitivity of one or more dosemeters is greater than 1.4 or less than 0.6:
   sending a sensitivity adjustment command from the central unit to the dosemeter or dosemeters, this sensitivity adjustment command being received by the wireless receiver of the or each dosemeter;
   transmitting the sensitivity adjustment command to the control unit;
   modifying, via the control unit, the position of the controllable potentiometer E²POT to adjust the detection threshold of the discriminator until the sensitivity of the dosemeter or dosemeters is between 0.6 and 1.4.

The sensitivity of the environmental dosemeters of the prior art is usually set by adding matter to the sensitive band which will pick up a certain portion of the radiation and thus reduce the sensitivity of the sensor.

According to the invention, the sensitivity is adjusted via the potentiometer E²POT 113, the adjustment of which affects the sensitivity of the sensor. This constitutes a simple technical means for compensating the sensitivity of the sensor in the case of response deviation. This compensation is done electronically and remotely, which avoids the requirement for a technician call-out.

Alternatively, or in combination, the control unit of a dosemeter according to the invention is linked to a diode 114 which is switched on and off at the control of the control unit 103 and which is suitable for illuminating, for an adjustable determined time, the photodiode 101 sensitive to the radiations to be detected in order to check the correct operation of the dosemeter.

This test of the operation of one or more dosemeters comprises the following steps:
sending a test command from the central unit to one or more dosemeters, this test command being received by the wireless receiver of the or each dosemeter;
transmitting the received test command to the control unit;
ordering, via the control unit, a diode 114 arranged to illuminate the photodiode 101 sensitive to the radiations to be detected to be switched on for a predefined duration;
converting electrical signals generated by the photodiode of each dosemeter into a data signal, preferably raw binary data;
sending at least a part of the data signal via the wireless transceiver to the central unit, possibly via a relay terminal;
using the central unit to check that the received signal corresponds to the test command sent;
activating an alarm if the received signal does not correspond to the test command.

The invention therefore proposes a system for monitoring environmental dosimetry that makes it possible to know the dose detected almost immediately, that is easy to deploy in extensive pre-existing premises and without having to do any significant installation work, that is efficient because the calibration of the dosemeters can be performed automatically and remotely, and that is cost effective because it requires no installation/de-installation management, it requires only limited annual maintenance, and it limits the production of waste to the cells that are changed annually.

According to other embodiments, the dosemeter may comprise a plurality of photodiodes (for example two) each linked to a discriminator. This makes it possible to simplify the detection in the case of a strong dose.

In addition to the various commands that each dosemeter can receive during the “listening” phase of the transceiver 104, the invention provides the possibility for each dosemeter to be able to receive an acknowledgement of reception of the data from the central unit. Thus, in the case of absence of this acknowledgement of reception, provision can be made for a retransmission of the data and/or for an alarm signal to be sent, via the relay terminals, to devices such as laptop computers 400, personal digital assistants (PDA), cell phones, etc. However, the dosemeter according to the invention is not equipped with any audible or visual alarm. It can simply, if necessary, transmit a signal which activates a remote alarm, this alarm being carried by the devices receiving the alarm signal.

Moreover, the structure of the dosemeter according to the invention and of the dosimetry system according to the invention makes it possible to reprogram a dosemeter occasionally for it to be used as a relay terminal. This reprogramming must be occasional because the relay terminal function consumes energy.

An exemplary application of such reprogramming is the occasional (every few days) dosimetry monitoring of a room which is out of range of the relay terminals 200 but not of a dosemeter 600 according to the invention (see FIG. 1). For example, it may be necessary to monitor the environmental dosimetry of a room to which a patient is assigned from time to time. In this case, the central unit is used to reprogram the dosemeter 100 or 110 (within communication range of the dosemeter 700 temporarily installed in the room) for it to become a relay dosemeter 600 which relays the data sent by the dosemeters 700 to the relay terminals 200 and to the central unit 300.

Thus, the system for monitoring environmental dosimetry according to the invention is not only easy to deploy, but can also be very easily adapted to the operating conditions and opportunities of the premises for which the environmental dosimetry has to be monitored.

1. A system for monitoring environmental dosimetry, characterized in that it comprises:
a plurality of dosemeters not equipped with a display screen, each comprising a photodiode sensitive to the radiations to be detected, a discriminator that transforms a pulse representative of the detection of a radiation into a pulse that can be counted by a control unit, at least one charge amplifier arranged between the photodiode sensitive to the radiations to be detected and the discriminator, the control unit being in turn connected to a wireless transceiver for the transmission of data representative of the radiations detected by each dosemeter;
at least one relay terminal comprising a wireless transceiver suitable for communicating with at least some of the transceivers of the dosemeters and with at least one central unit for tracking the environmental dosimetry.

2. The system for monitoring environmental dosimetry as claimed in claim 1, in which the plurality of dosemeters is also not equipped with any radioactive dose computer, in which the control unit is suitable for transmitting, via the wireless transceiver, raw data representative of the radiations detected by each dosemeter, and in which the central unit is suitable for calculating the radiation dose picked up by each dosemeter from the raw data.

3. The system for monitoring environmental dosimetry as claimed in claim 1, in which the transceiver of each dosemeter operates asymmetrically such that each dosemeter has less time for transmitting raw data than time for receiving information from said at least one central unit via said at least one relay terminal.

4. The system for monitoring dosimetry as claimed in claim 1, also comprising a memory for storing the doses calculated by the central unit.

5. The system for monitoring environmental dosimetry as claimed in claim 1, also comprising an alarm that can be activated by the central unit where a calculated dose exceeds a predefined threshold.

6. A dosemeter for implementing the system for monitoring environmental dosimetry as claimed in claim 1, comprising at least one photodiode sensitive to the radiations to be detected, characterized in that the or each photodiode is connected to a control unit via a discriminator that transforms a pulse representative of the detection of a radiation into a pulse that can be counted by the control unit, at least one charge amplifier arranged between the photodiode sensitive to the radiations to be detected and the discriminator, the control unit being in turn connected to a transceiver for the transmission of the data detected by the diode, the dosemeter not being equipped with a display screen.

7. The dosemeter as claimed in claim 6, said dosemeter not being equipped with a computer for calculating the detected radioactive dose, the control unit being suitable for transmitting, via the transceiver, the raw data generated by the discriminator.

8. The dosemeter as claimed in claim 6, in which the control unit comprises a clock for controlling the transceiver asymmetrically so that it has a transmission time that is shorter than a reception time.

9. The dosemeter as claimed in claim 6, in which the control unit is linked to a calibration filter suitable for transforming binary pulses, transmitted by the control unit and with a parameterizable duration, into pulses identical to what the photodiode produces when it is subjected to a radiation in order to adjust the discriminator.

10. The dosemeter as claimed in claim 6, in which the control unit is linked to a potentiometer (E²POT) that can be controlled by the control unit to electrically adjust a discriminator radiation detection threshold.

11. The dosemeter as claimed in claim 6, in which the control unit is linked to a diode which is switched on under the control of the control unit and which is arranged to illuminate the photodiode sensitive to the radiations to be detected in order to check the correct operation of the dosemeter.

12. An environmental dosimetry method, characterized in that it consists in using a system for monitoring environmental dosimetry as claimed in claim 1, and in that it comprises the following steps:
a) activating the dosemeters;
b) converting the electrical signals generated by the photodiode of each dosemeter into a data signal representative of the detected radiations;
c) sending at least a part of the data signal via the wireless transceiver to the central unit, possibly via at least one relay terminal.

13. The environmental dosimetry method as claimed in claim 12, in which the step b) consists in converting electrical signals generated by the photodiode of each dosemeter into a raw data signal, the method also comprising a step d) of calculating, with the central unit, the dose of radiations picked up by each photodiode from the transmitted raw data signal.

14. The environmental dosimetry method as claimed in claim 13, also comprising a step of calculating the dose of radiations picked up by each photodiode per time unit, the dose rate, to determine the change in trend over time of the dose picked up.

15. The environmental dosimetry method as claimed in claim 14, also comprising a step of activation of an alarm when the dose rate exceeds a predetermined threshold.

16. The environmental dosimetry method as claimed in claim 12, in which the transceiver of each dosemeter is controlled asymmetrically so that it has a transmission time that is shorter than a reception time.

17. The environmental dosimetry method as claimed in claim 13, in which the raw data signal of the step b) is a binary signal, and in which the step c) consists in sending all of the binary signal.

18. The environmental dosimetry method as claimed in claim 13, in which the raw data signal of the step b) is a binary signal, and in which the step c) consists in sending only a part of the binary signal, this part corresponding to an actual detection of a radiation, the untransmitted part corresponding to the absence of detection.

19. The environmental dosimetry method as claimed in claim 13, also comprising a step of testing the operation of one or more dosemeters, this step comprising the following substeps:
sending a test command from the central unit to one or more dosemeters, this test command being received by the wireless receiver of the or each dosemeter;
transmitting the received test command to the control unit;
ordering, via the control unit, a diode arranged to illuminate the photodiode sensitive to the radiations to be detected to be switched on for a predefined duration;
converting electrical signals generated by the photodiode of each dosemeter into a data signal;
sending at least a part of the data signal via the wireless transceiver to the central unit, possibly via a relay terminal;
using the central unit to check that the received signal corresponds to the test command sent;
activating an alarm if the received signal does not correspond to the test command.

20. The environmental dosimetry method as claimed in claim 12, also comprising a step of generating an alarm signal when the calculated dose exceeds a predetermined tolerance threshold, or when a communication failure between a dosemeter and the central unit is detected, or when a failure of operation of a dosemeter is detected.

21. The environmental dosimetry method as claimed in claim 12, also comprising a calibration step comprising the following substeps:
sending a calibration command from the central unit to one or more dosemeters, this calibration command being received by the wireless receiver of the or each dosemeter;
transmitting the received calibration command to the control unit;
in the absence of any irradiation of the photodiode (101), searching, with the control unit, for a position of a potentiometer that can be controlled such that the discriminator does not send any pulse despite an electronic noise from the charge amplifier (111);
generating, with the control unit (103), at least three series of a defined number of binary pulses of fixed amplitude, the pulses of the first series having a duration of 10 μs, the pulses of the second series having a duration of 20 μs, the pulses of the third series having a duration of 30 μs, the other series having a pulse duration incremented by 10 μs between each series, these binary pulses being transmitted to a calibration filter (112);
transforming, with the calibration filter, the binary pulses into pulses identical to what the photodiode produces when it is subjected to a photon;
counting the number of pulses generated by the discriminator and transmitted to the control unit (103) for each series of pulses;
establishing a ratio between the number of pulses of each series and the number of pulses generated in response by the discriminator;
adjusting the controllable potentiometer until approximately 10% of the pulses of the first series generate a response from the discriminator, approximately 30% of the pulses of the second series generate a response from the discriminator and approximately 50% of the pulses of the third series generate a response from the discriminator.

22. The environmental dosimetry method as claimed in claim 12, also comprising a step of adjusting the detection sensitivity of one or more dosemeters, comprising the following substeps:
measuring the sensitivity of one or more dosemeters at different energies between 10 and 3000 keV (kilo electron volt) relative to cesium 137;
if the sensitivity of one or more dosemeters is greater than 1.4 or less than 0.6:
sending a sensitivity adjustment command from the central unit to the dosemeter or dosemeters, this sensitivity adjustment command being received by the wireless receiver of the or each dosemeter;
transmitting the sensitivity adjustment command to the control unit; controlling, via the control unit, a controllable potentiometer (E²POT) to adjust the detection threshold of the discriminator until the sensitivity of the dosemeter or dosemeters is between 0.6 and 1.4.
